(19) United States
(12) Patent Application Publication
(10) Pub. No.: US 2006/0207136 A1
(43) Pub. Date: Sep. 21, 2006

(54) Modular scroll sign display system

(75) Inventor: Dieter Blum, Aldergrove (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Sluggo Lighting Ltd., Aldergrove (CA)

(21) Appl. No.: 11/177,430

(22) Filed: Jul. 11, 2005

Related U.S. Application Data
(60) Provisional application No. 60/663,264, filed on Mar. 21, 2005.

(30) Foreign Application Priority Data
Mar. 21, 2005 (CA) 2501726

(51) Int. Cl. G09F 11/02

(52) U.S. Cl. 40/473

(57) ABSTRACT

One aspect of the invention provides scroll sign modules having laterally spaced-apart side frame members which support a pair of tape transport rolls therebetween. The axes of the rolls are parallel to each other. A tape, typically bearing visual indicia, extends between the two parallel rolls. A portion of the tape is wrapped around at least one of the rolls. Two controllable motors are mounted with at least a portion of each motor located in a bore of a corresponding one of the rolls. Each motor is operationally coupled to rotate its corresponding roll about its axis.

### RELATED APPLICATIONS

This application claims the benefit of the 21 Mar. 2005 filing date of U.S. application No. 60/663,264 under 35 U.S.C. § 119(e) and the 21 Mar. 2005 filing date of Canadian application No. 2,501,726 under 35 U.S.C. § 119(a).

### TECHNICAL FIELD

The invention relates to scroll sign display systems which have scrollable tapes of media bearing printed information, graphics or other indicia.

### BACKGROUND OF THE INVENTION

Storage of visual information, graphics and other indicia on scrollable tapes of media is known. Tapes (also known as webs or films) of media are commonly opaque and reflective (i.e. for front illumination) or translucent and partially reflective (i.e. for a combination of front and/or rear illumination).

Systems incorporating scrollable tapes of media are referred to in this description as “scroll sign display systems” or “scroll signs”. Scroll signs have many applications, such as the display of product prices or other information. For example, petroleum service stations may use scroll signs to display the price of fuel. Scroll signs may be used to show pricing information for a plurality of different grades of fuel, with the pricing information for each grade made up of a plurality of digits. Scroll signs used for such an application typically include a plurality of “scroll sign modules”, each scroll sign module having its own scrollable tape for displaying one digit or other indicia. The individual scroll sign modules may be arranged in several banks, with each bank made up of a number of individual scroll sign modules (i.e. a number of individual digits). In this manner, each bank of scroll sign modules can display the price for one particular grade of fuel.

In applications such as the display of fuel prices, it is generally desirable that the information displayed by a scroll sign be humanly readable from a substantial distance. One technique for increasing the visibility of this information involves mounting the scroll sign on a tall pole adjacent to a traffic thoroughfare. This permits the information on the individual scroll sign modules to be seen from a relatively large distance.

Typically, scroll signs comprise a control system located in the sign or in a vicinity of the sign and a remotely located operator interface which communicates with the control system to allow an operator to control the individual scroll sign modules from the remote location.

Several types of scroll sign modules are known, differing mainly in their drive/actuation mechanisms and associated circuitry. A typical scroll sign module incorporates a drive means, such as an electric motor, and a pair of spaced apart parallel rolls capable of rotation about their longitudinal axes. The drive means is operatively coupled in a driving relationship with at least one of the rolls by way of a suitable drive mechanism. The tape of media bearing visual information is wrapped around the two spaced-apart parallel rolls, such that when the tape is wound on a first one of the rolls, it is unwound from the other one of the rolls. The rolls are spaced-apart from one another, such that indicia on a portion of the tape between the rolls are exposed for viewing through a display aperture in the scroll sign.

In typical scroll sign modules, the two spaced-apart parallel rolls include one “drive roll”, which is coupled to be driven by the drive means, and a “tension roll”. A tensioning device may be coupled to the tension roll to maintain sufficient tension on the tape. A tensioning device may additionally or alternatively couple the tension roll to the drive means. Tension on the tape, particularly in the region between the drive roll and the tension roll, is desirable to enhance the visibility of the indicia on the tape.

Prior art scroll signs include:
U.S. Pat. No. 734,982 (Smith), issued Jul. 28, 1903;
U.S. Pat. No. 1,024,044 (Tucker), issued Apr. 23, 1912;
U.S. Pat. No. 1,547,495 (Galley), issued Jul. 28, 1925;
U.S. Pat. No. 1,902,884 (Wagner), issued Mar. 28, 1933;
U.S. Pat. No. 3,255,541 (Bettcher), issued Jun. 14, 1966;
U.S. Pat. No. 3,616,554 (Finger et al.), issued Nov. 2, 1971;
U.S. Pat. No. 4,110,925 (Strand et al.), issued Sep. 5, 1978;
U.S. Pat. No. 4,205,801 (Decaux), issued Jun. 3, 1980;
U.S. Pat. No. 4,680,883 (Stadjuhar et al.), issued Jul. 21, 1987;
U.S. Pat. No. 4,773,176 (Grehan), issued Sep. 27, 1988;
U.S. Pat. No. 5,003,717 (Trame et al.), issued Apr. 2, 1991;
U.S. Pat. No. 5,673,504 (Brown), issued Oct. 7, 1997;
U.S. Pat. No. 5,940,999 (Harruff et al. No. 1), issued Aug. 24, 1999; U.S. Pat. No. 5,979,093 (Harruff et al. No. 2), issued Nov. 9, 1999;
AU Patent No. 596,441 (AU '441), in the name of the Milwaukee Sign Company; and
EP Patent Publication No. 0253033 (EP '033), in the name of World Acrilux S.A.

Generally desirable characteristics for individual scroll sign modules include:
an ability to drive the rolls, and thereby scroll the tape, bi-directionally (i.e. to take-up the tape on one roll while releasing the tape from the other roll), so as to position the indicia on the tape for display;
provision of tension on the tape to enhance the visibility of indicia contained on the tape and to compensate for changes in the effective diameters of the rolls as portions of the tape are wound and unwound thereupon;
provision of tape position sensing and control to ensure the proper alignment and display of indicia contained on the tape within a display aperture of the scroll sign; and
provision of a drive mechanism that is simple in construction and assembly, fabricated from low cost materials, small and compact (i.e. to fit within the interior cavity of the frame of the scroll sign module and to avoid casting undesirable shadows).

Prior art scroll sign modules have a number of deficiencies. These deficiencies may relate to one or more of the above-identified characteristics and may also relate to other drawbacks associated with the particular prior art design. It is desirable, therefore, to provide a scroll sign module that ameliorates at least some of the deficiencies of the prior art.

Generally desirable characteristics for scroll signs as a whole include:
a design which permits relatively simple physical deployment and/or replacement of scroll sign modules, preferably without the requirement for cumbersome module address programming;
a control system, which comprises a minimal amount of electronic circuitry and which is located within or in close proximity to the scroll sign; and
a control system, which comprises a minimal amount of wiring interconnections between the controller and the individual scroll sign modules.

Prior art scroll signs have a number of deficiencies. These deficiencies may relate to one or more of the above-identified characteristics and may also relate to other drawbacks associated with the particular prior art design. It is desirable, therefore, to provide a scroll sign that ameliorates at least some of the deficiencies of the prior art.

### SUMMARY OF INVENTION

One aspect of the invention provides scroll sign modules having laterally spaced-apart side frame members which support a pair of tape transport rolls therebetween. The axes of the rolls are parallel to each other. A tape, typically bearing visual indicia, extends between the two parallel rolls. A portion of the tape is wrapped around at least one of the rolls. Two controllable motors are mounted with at least a portion of each motor located in a bore of a corresponding one of the rolls. Each motor is operationally coupled to rotate its corresponding roll about its axis.

Corresponding terminals of both motors may be connected through opposing polarity diodes to a common drive signal terminal. The opposing terminals of both motors may be directly connected to a common ground terminal. The drive signal terminal may be driven with a positive signal or a negative signal. When the drive signal terminal is driven with a positive signal, a first one of the opposing polarity diodes is forward biased, such that a first motor receives a positive drive signal and causes the tape to scroll in a first direction. Scrolling the tape in the first direction may cause corresponding rotation of a second motor, thereby creating a back EMF in the second motor and corresponding current that flows through the opposing polarity diodes to provide an assistive drive signal to the first motor which tends to help scroll the tape in the first direction. When the drive signal terminal is driven with a negative signal, a second of the opposing polarity diodes is forward biased, such that the second motor receives a negative drive signal and causes the tape to scroll in a second direction. Scrolling the tape in the second direction may cause corresponding rotation of the first motor, thereby creating a back EMF in the first motor and corresponding current that flows through the opposing polarity diodes to provide an assistive drive signal to the second motor which tends to help scroll the tape in the second direction.

Another aspect of the invention provides a control system for one or more scroll sign modules. The control system comprises a driving circuit having, for each scroll sign module and each corresponding pair of motors, a bi-directional switch capable of sourcing drive current to, and sinking drive current from, a common drive signal terminal which is shared by the pair of motors. The control system dispenses with the conventional H-bridge and half-bridge driver topologies, lowering the cost and complexity of the overall display system.

The control system may provide for minimal interconnect wiring between the control system and its associated scroll sign module(s), thereby further lowering the cost and complexity of the overall scroll sign and also easing scroll sign configuration, assembly, calibration and servicing.

Another aspect of the invention provides a method for displaying one of a plurality of indicia on a tape that scrolls between first and second spaced-apart rolls. The method comprises providing first and second motors, the first motor operatively coupled to drive the first roll and the second motor operatively coupled to drive the second roll. The method involves imparting a first drive signal to the first motor, thereby driving the first roll and scrolling the tape in a first direction. Scrolling the tape in the first direction rotates the second motor in the first direction to develop a back EMF in the second motor. Preferably, rotating the second motor in the first direction provides a resistance to scrolling the tape in the first direction and a desirable tension on the tape. Preferably, the back EMF developed in the in the second motor assists the first motor to scroll the tape in the first direction. The method may involve connecting the first and second motors through opposing polarity diodes to a common drive signal terminal.

Further features of specific embodiments of the invention, aspects of the invention and applications of the invention are described below.

### BRIEF DESCRIPTION OF DRAWINGS

In drawings which illustrate non-limiting embodiment of the invention:

FIG. 1 is a schematic partially cross-sectioned side view of a scroll sign module according to a particular embodiment of the invention;

FIG. 2 is a schematic partially cross-sectioned rear view of the FIG. 1 scroll sign module;

FIG. 3 is a partially cross-sectioned side view of a portion of a two-sided scroll sign having a pair of scroll sign modules of the type depicted in FIG. 1;

FIG. 4 is a schematic diagram of a scroll sign comprising a plurality of banks, each bank comprising a plurality of scroll sign modules;

FIG. 5 is a schematic wiring diagram of a scroll sign having a plurality of banks, each bank comprising a plurality of scroll sign modules;

FIG. 6 is a schematic block diagram of a scroll sign and a remotely located operator interface according to a particular embodiment of the invention;

FIG. 7 is a partial schematic block diagram of a scroll sign control system according to a particular embodiment of the invention;

FIG. 8 is a schematic depiction of the operation of the FIG. 1 dual motor scroll sign module by the FIG. 7 control system;

FIG. 9 is a partial schematic block diagram of a scroll sign control system according to an alternative embodiment of the invention;

FIG. 10 is a schematic diagram of the wiring interconnections between the FIG. 7 control system and a single bank of scroll sign modules;

FIG. 11 is a schematic diagram of the wiring interconnections between the FIG. 9 control system and a single bank of scroll sign modules; and

FIG. 12 is a schematic flow chart of a method for operating the FIG. 1 dual motor scroll sign module using the FIG. 7 control system.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

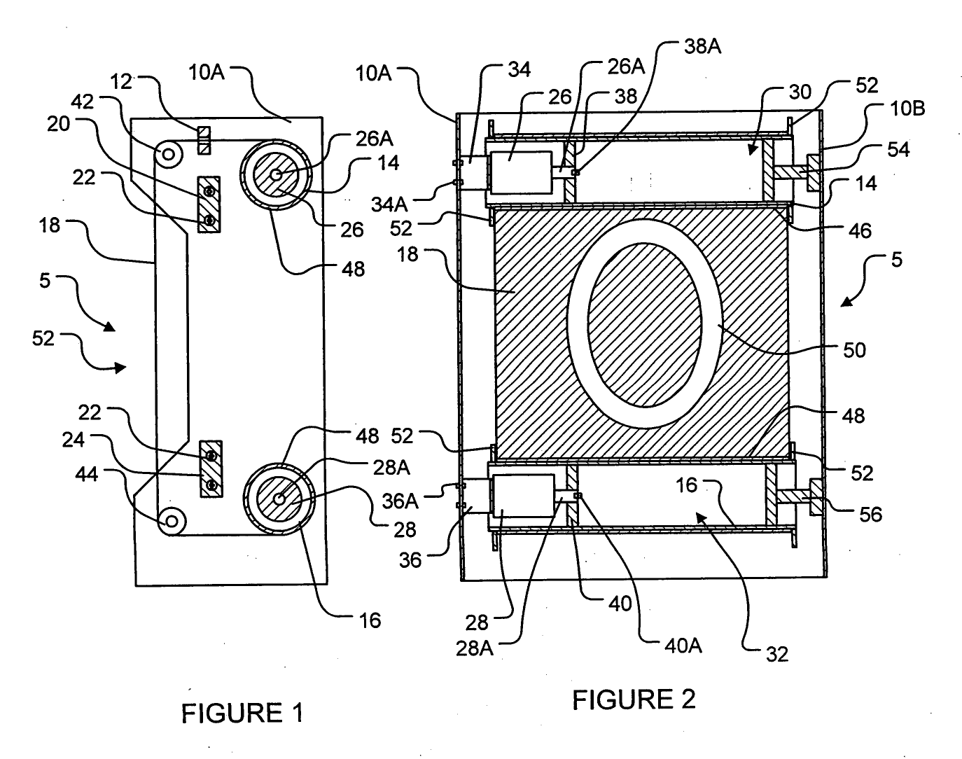

FIG. 1 and FIG. 2 respectively show partially cross-sectioned side and partially cross-sectioned rear views of a scroll sign module 5 according to a particular embodiment of the invention. Scroll sign module 5 comprises a pair of side frame members 10A, 10B, which are connected to one another via cross-rails 20, 24 and fasteners 22. Together, side frame members 10A, 10B and cross-rails 20, 24 provide a frame to which other components of scroll sign module 5 may be mounted.

Scroll sign module 5 comprises a pair of parallel, spaced-apart rolls 14, 16 which facilitate the storage, displacement and display of tape 18. Typically, tape 18 is a plastic film bearing information, graphics or other indicia. Tape 18 may comprise other materials. Tape 18 may be opaque and reflective (i.e. for front illumination) or translucent and partially reflective (i.e. for front and/or rear illumination). The outer surfaces of rolls 14, 16 are substantially cylindrical in shape and may be constructed from any suitable material, including suitable metals or plastics. In the illustrated embodiment, each roll 14, 16 comprises a pair of flanges 52 at its outer ends. Flanges 52 serve to guide and/or align tape 18 on rolls 14, 16.

Scroll sign module 5 also comprises a pair of electric motors 26, 28 which are respectively coupled to drive rotation of roll 14 and roll 16. Motors 26, 28 are respectively located within the bores 30, 32 of rolls 14, 16. In the illustrated embodiment, motors 26, 28 comprise internal gearing mechanisms which reduce the rotational speeds of their respective shafts 26A, 28A. External gearing mechanisms could be also used.

In the illustrated embodiment, motors 26, 28 are mounted to side frame member 10A by brackets 34, 36 and corresponding fasteners 34A, 36A. Brackets 34, 36 hold the body of motors 26, 28 in fixed relation to side frame member 10A. In the illustrated embodiment, brackets 34, 36 are L-shaped angle brackets. However, brackets 34, 36 may generally be of any suitable shape and may generally use any suitable mechanism to fix the body of motors 26, 28 to either (or both) of side frames 10A, 10B.

In the illustrated embodiment, motor shafts 26A, 26B are operatively coupled to hubs 38, 40 (by fasteners 38A, 40A) and hubs 38, 40 are operatively coupled to rolls 14, 16, such that rotation of motor shafts 26A, 26B causes corresponding rotation of hubs 38, 40 and rolls 14, 16 with respect to side frame members 10A, 10B. Locating motors 26, 28 in bores 30, 32 of rolls 14, 16 saves space, allowing for the use of two motors within a single scroll sign module. Motor shafts 26A, 26B may be additionally or alternatively coupled to hubs 38, 40 using any suitable mechanism, such as mating gears, male and female keys or the like.

Hubs 38, 40 may be coupled to rolls 14, 16 using a variety of techniques. For example, hubs 38, 40 may be coupled to rolls 14, 16 by suitable fasteners (not shown), friction fits, welding or use of suitable adhesives. Hubs 38, 40 may also be integrally formed with rolls 14, 16. Preferably, if fasteners are used to couple hubs 38, 40 to rolls 14, 16, the fasteners do not project radially outwardly past the circumferential surface of rolls 14, 16. In the illustrated embodiment, hubs 38, 40 are disc-shaped. However this shape is not a requirement, as hubs 38, 40 may comprise one or more spokes or tabs which operatively connect motor shafts 26A, 26B to rolls 14, 16.

In the illustrated embodiment, rolls 14, 16 are respectively coupled to side frame 10B via pivot joints 54, 56. Pivot joints 54, 56 allow rolls 14, 16 to rotate with respect to side frame 10B. Coupling rolls 14, 16 to side frame 10B may provide scroll sign module 5 with increased robustness and durability. However, in alternative embodiments, rolls 14, 16 are only coupled to side frame 10B. In other alternative embodiments, rolls 14, 16 may be additionally or alternatively be coupled to other frame components, such as cross-rails 20, 24.

In the illustrated embodiment, scroll sign module 5 also comprises a pair of idler rollers 42, 44. As shown best in FIG. 1, tape 18 is entrained around upper roll 14, upper idler roller 42, lower idler roller 44 and lower roll 16. Tape 18 may be wrapped several times around the cylindrical surface(s) of upper roll 14 and/or lower roll 16. Tape 18 may be rolled back and forth between upper roll 14 and lower roll 16 to display different indicia.

At any given time, the “effective diameters” of upper roll 14 and lower roll 16 depend on the thickness 46, 48 of tape 18 wrapped around their respective cylindrical surfaces (see FIG. 2). As explained further below, tension is maintained on tape 18 as it extends between upper roll 14 and lower roll 16 by suitable control of motors 26, 28. This tension takes-up any excess and/or releases any shortage of tape 18 which may be caused by variation of the effective diameters of rolls 14, 16.

Scroll sign module 5 also comprises a sensor 12 for detecting a position of tape 18 relative to rolls 14, 16. In the illustrated embodiment, sensor 12 is an optoelectronic sensor, wherein at least a portion of tape 18 passes under (or through) the operative portion of sensor 12. Tape 18 may be provided with coded bars, stripes or other optically detectable information (not shown), which may be detected by sensor 12 to provide information about the position of tape 18. Of particular relevance when determining the position of tape 18, is the position of the indicia portion 50 of tape 18 relative to display aperture 52, which may be located between idler rollers 42, 44.

In the illustrated embodiment, the representative indicia portion 50 of tape 18 displays the number “0”. Tape 18 may be provided with particular patterns of coded bars, which indicate that a particular indicia portion 50 of tape 18 is positioned properly relative to display aperture 52. Such patterns of coded bars may comprise different optical properties, such as different reflectivity, transmissivity or absorptivity. Such patterns of coded bars may be provided at spaced-apart locations over the length of tape 18 and each pattern of coded bars may be unique to a particular indicia on tape 18, such that tape 18 and sensor 12 act as an absolute position encoder. Additionally or alternatively, the coded bars may be positioned at periodic intervals over the entire length of tape 18 to provide a continual count that relates to the position of tape 18. Tape 18 may also be provided with a calibration feature, such as a long period of transparent tape for example, which allows sensor 12 to determine a “home position reference”. In this manner, tape 18 and sensor 12 could function as a relative position encoder. In preferred embodiments, sensor 12 functions as both an absolute and relative position encoder.

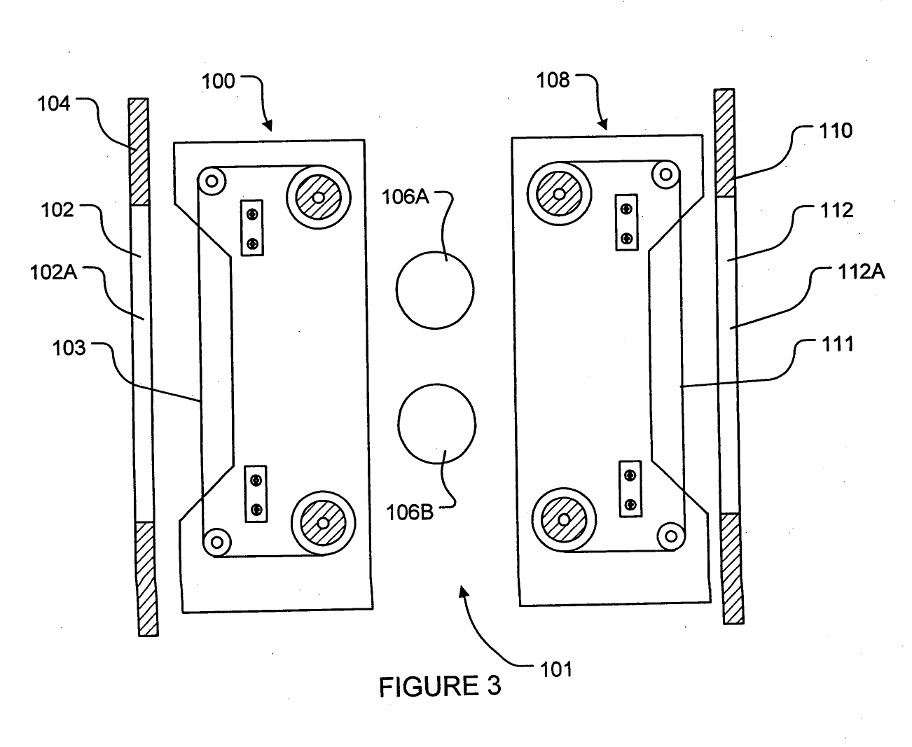

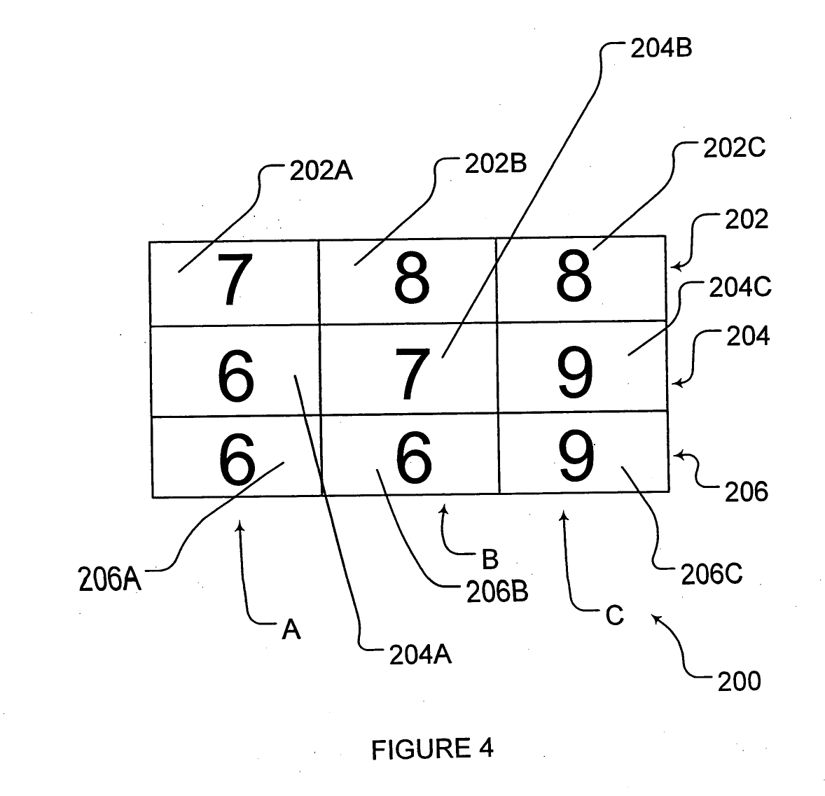

FIG. 3 is a partially cross-sectioned side view of a portion of a two-sided display sign system 101 comprising a pair of scroll sign modules 100, 108 of the type shown in FIGS. 1 and 2 and a pair of lights 106A, 106B. For clarity, mounting details of scroll sign modules 100, 108 are not shown in FIG. 3. Sign 101 also comprises left and right hand facia 104, 110, each of which includes an associated transparent window portion 102, 112. Transparent window portions 102, 112 may comprise transparent window members 102A, 112A, which may be fabricated from plastic or glass, for example. Transparent window portions 102, 112 are aligned with the display apertures of scroll sign modules 100, 108 (see display aperture 52 of FIG. 1).

The indicia on tape 103 of scroll sign module 100 may be viewed through the display aperture of scroll sign module 100 and transparent window portion 102 of sign 101. Similarly, the indicia on tape 111 of scroll sign module 108 may be viewed through the display aperture of scroll sign module 108 and transparent window portion 112 of sign 101. Aside from transparent window portions 102, 112, the remainder of left and right hand facia 104, 110 may be opaque or semitransparent and may be coloured or bear various grahics.

In a typical application, the indicia on tapes 103, 111 have sufficient contrast (relative to the background of tapes 103, 111) to be readily viewable under ambient daylight conditions. Under such light conditions, ambient illumination enters sign 101 through transparent window portions 102, 112 and reflects from tapes 103, 111, so that the indicia on tapes 103, 111 may be viewed. Under such light conditions, scroll sign modules 100, 108 are said to operate in a reflective mode.

Under low-light conditions, tapes 103, 111 may be illuminated from their rear sides by lights 106. Lights 106 may be fluorescent lamps, for example. Light from lights 106 is transmitted through tapes 103, 111, so that the indicia on tapes 103, 111 may be viewed. When operating with illumination from lights 106, scroll sign modules 100, 108 are said to operate in a transmissive mode.

FIG. 4 is a schematic diagram on a scroll sign display system 200 comprising three banks 202, 204, 206 of scroll sign modules. Bank 202 comprises three individual scroll sign modules 202A, 202B, 202C. Similarly, banks 204 and 206 each comprise three individual scroll sign modules 204A, 204B, 204C and 206A, 206B, 206C. In the illustrated embodiment, each individual scroll sign module displays one digit of information. The individual scroll sign modules which have the same position within each bank 202, 204, 206 may be referred to as a column of scroll sign modules. For example, column A comprises scroll sign modules 202A, 204A, 206A, column B comprises scroll sign modules 202B, 204B, 206B and column C comprises scroll sign modules 202C, 204C, 206C.

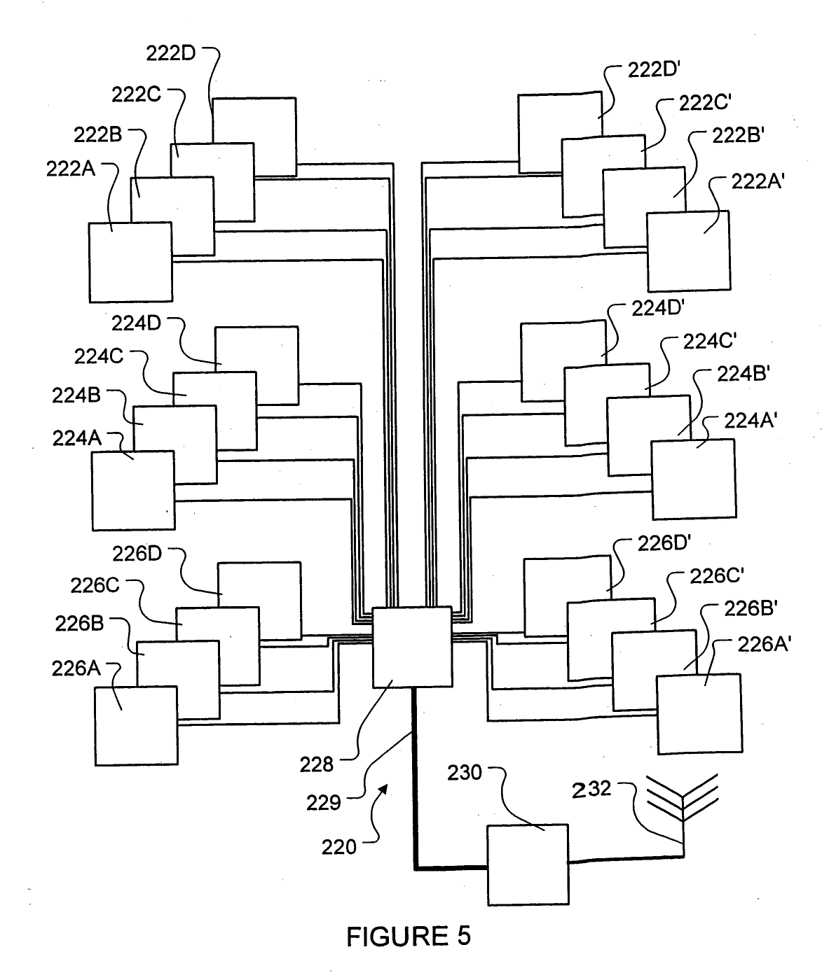

FIG. 5 is a schematic wiring diagram of a scroll sign 220 having a plurality of opposing banks 222 and 222′; 224 and 224′; 226 and 226′. In the illustrated scroll sign 220, each bank 222, 222′, 224, 224′, 226, 226′ includes four individual scroll sign modules (e.g. 222A, 222B, 222C, 222D and 222A′, 222B′, 222C′, 222D′). Each scroll sign module is connected to breakout box 228 via an associated wiring harness. The wiring harnesses associated with each scroll sign module may comprise a plurality of individual wires to provide a plurality of electrical connections to breakout box 228. Preferably, however, the number of wires in the wiring harness associated with each scroll sign module is minimized as explained in more detail below to minimize the cost of, and the space occupied by, the wires and the associated electrical connectors.

Wiring harness 229 connects breakout box 228 to sign controller 230. An individual scroll sign module may be replaced by simply unplugging it from its associated wiring harness and plugging in a replacement scroll sign module. Preferably, no addressing or other software or hardware reconfiguration is required and controller 230 is capable of recalibrating itself.

In some embodiments, upon replacement of a scroll sign module, controller 230 and sensor 12 (FIG. 1) detect the absolute position of tape 18 as between a plurality of distinct stopping locations corresponding to distinct indicia on tape 18. In such embodiments, tape 18 comprises optical features, which may be detected by sensor 12 and discerned by controller 230, to provide absolute position information. In alternative embodiments, upon replacement of a scroll sign module, controller 230 and sensor 12 cause tape 18 to move to a home position reference, whereupon sensor 12 is capable of detecting and controller 230 is capable of discerning the relative position of tape 18 relative to the home position reference. In preferred embodiments, controller 230 and sensor 12 are capable of both absolute and relative position encoding.

Breakout box 228 may be a completely passive connection device. Alternatively, breakout box 228 may house steering diodes or other components used to control the scroll sign modules. Preferably, breakout box 228 is contained within, or located in a close proximity to, sign 220, but is external to the individual scroll sign modules.

Those skilled in the art will appreciate that breakout box 228 is not necessary. Wiring harness 229 from sign controller 230 may comprise a plurality of individual wiring harnesses which connect directly to the individual scroll sign modules. For clarity, except where specifically indicated, the remainder of this description uses the phrase “wiring harness” to describe the entire connection between an individual scroll sign module and sign controller 230, including the connection through breakout box 228 (if present).

As discussed in more detail below, controller 230 controls the motors within the individual scroll sign modules by sending electrical signals through their associated wiring harnesses. Controller 230 is preferably contained within, or located in a close proximity to, sign 220, but is external to the individual scroll sign modules. Controller 230 may be connected to remote control device(s) 232 which enable a user to configure sign 220 from a remote location. Such remote control device(s) are well known to those skilled in the art.

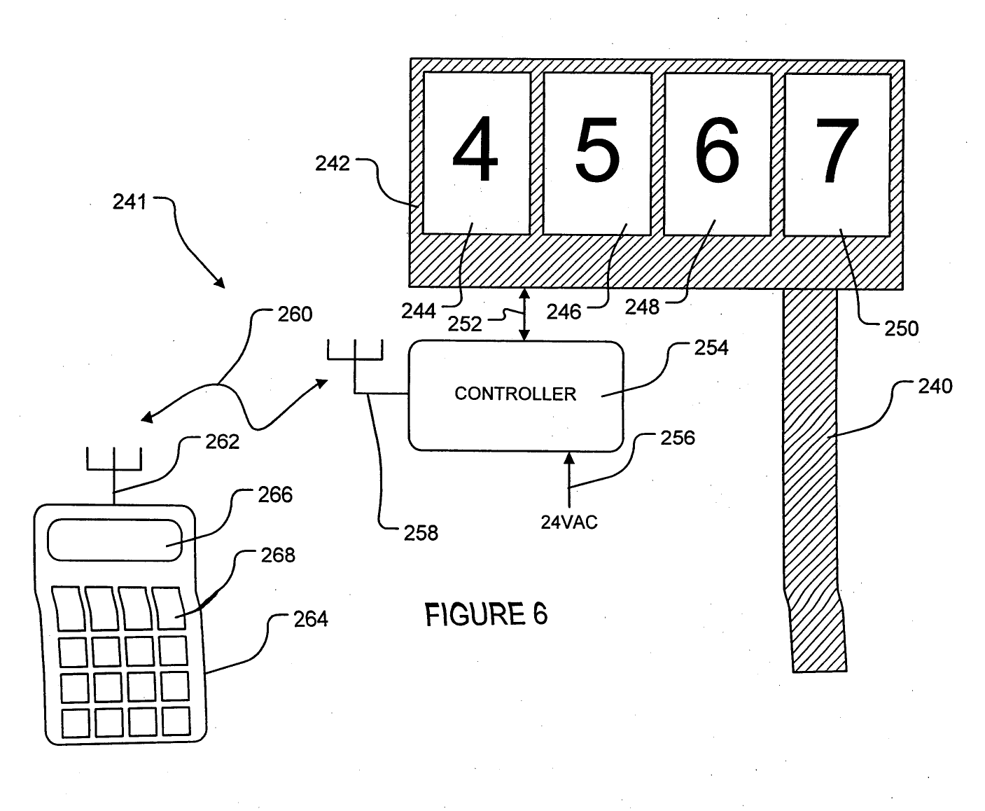

FIG. 6 is a schematic block diagram of a scroll sign 241 in accordance with a particular embodiment of the invention. Scroll sign 241 comprises a single-sided display sign housing 242 mounted to a sign support 240. For clarity, scroll sign 201 is depicted with only a single bank of four individual scroll sign modules 244, 246, 248, 250. Scroll sign 241 comprises a control system 254. Control system 254 is supplied with electrical power via line 256, which, in the illustrated embodiment, is shown as 24V AC. FIG. 6 shows control system 254 exterior to sign housing 242 for explanatory purposes. However, control system 254 is preferably located within sign housing 242. Control system 254 is connected to scroll sign modules 244, 246, 248, 250 via wiring harness(es) 252. Wiring harness(es) 252 comprise a number of connectors. The number of connectors is determined, at least in part, by the architecture of control system 254.

Control system 254 is also shown with remote control device(s) 258 for bi-directional communication between control system 254 and a remotely located operator interface unit 264. In the illustrated embodiment, interface unit 264 comprises an antenna 262 for bi-directional communication with control system 254. Interface unit 254 also comprises a display component 266 (e.g. a LCD) and data entry component 268 (e.g. a keypad). Display component 266 and data entry component 268 provide an operator interface to scroll sign display system 241.

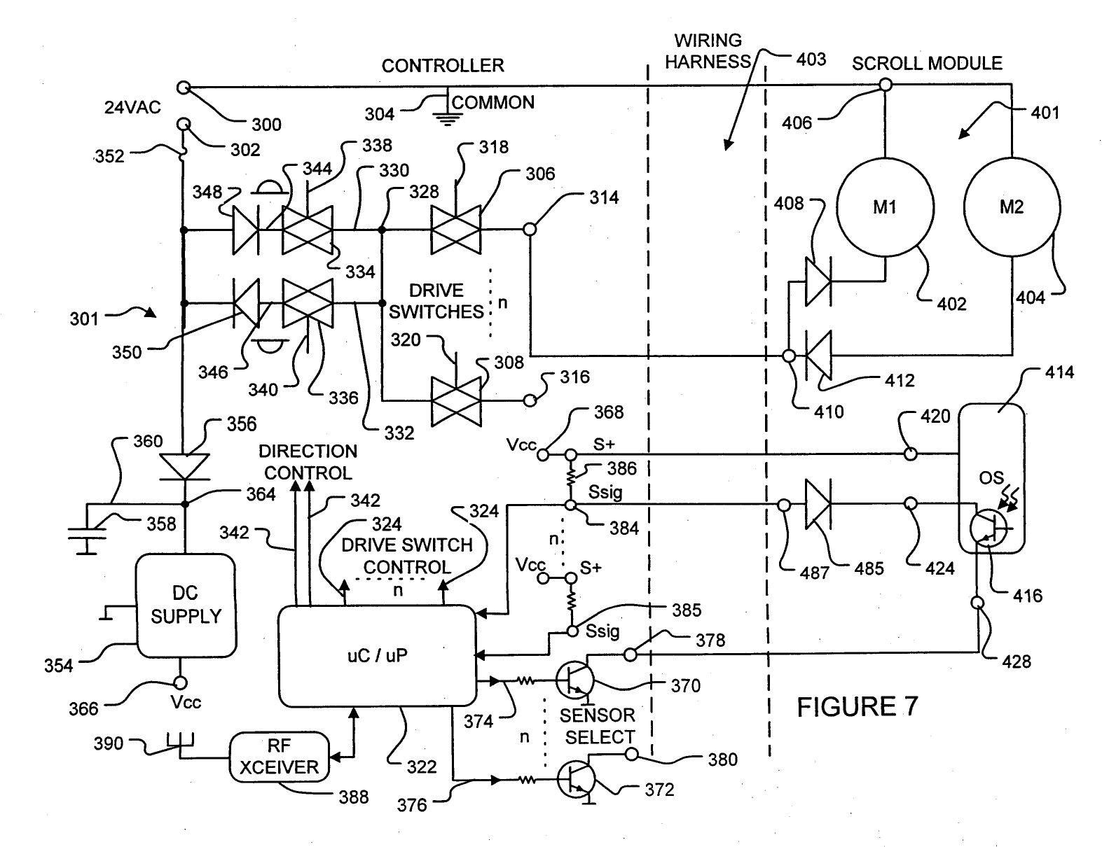

FIG. 7 is a partial schematic block diagram of a scroll sign control system 301 according to a particular embodiment of the invention. Control system 301 is capable of controlling one or more scroll sign modules. In most applications, control system 301 controls a scroll sign comprising a plurality of banks, with each bank comprising a plurality of individual scroll sign modules. More particularly, control system 301 controls the position of the tapes 18 (FIGS. 1 and 2) of the individual scroll sign modules, such they display the desired indicia.

For the sake of clarity, FIG. 7 depicts only one representative scroll sign module 401. As shown in FIG. 7, the wiring harness 403 between control system 301 and scroll sign module 401 comprises only five connections (i.e. scroll sign module 401 is connected to control system 301 using only five conductors). In the FIG. 7 embodiment, wiring harness 403 is passive in the sense that it does not have any active electronic components.

As discussed above, representative scroll sign module 401 comprises a pair of electrical motors 402, 404 which are respectively coupled to rolls 14, 16 (FIGS. 1 and 2). Motors 402, 404 may be 12 volt or 24 volt DC motors, for example. Motor 402 is connected to ground terminal 406 and through steering diode 408 to drive signal terminal 410. Motor 404 is connected to ground terminal 406 and is connected to drive signal terminal 410 via steering diode 412 which has a polarity opposite that of steering diode 408. In the FIG. 7 embodiment, steering diodes 408, 412 are located within scroll sign module 401. Locating steering diodes 408, 412 within scroll sign module 401 provides the advantage that wiring harness 403 requires fewer connections between control system 301 and scroll sign module 401.

Representative scroll sign module 401 also comprises a position sensor 414, which senses the position of tape 18 relative to rolls 14, 16 (FIGS. 1 and 2). In the illustrated embodiment, sensor 414 comprises an open collector circuit 416, which is connected between power signal terminal 420, sensor signal (“Ssig”) terminal 424 and sensor activation terminal 428. Those skilled in the art will appreciate that other types of sensors may be used to implement position sensor 414 and that sensor 414 need not be embodied by an open collector circuit. The invention should be understood to include any type of sensor capable of detecting a position of tape 18 and any suitable circuit capable of extracting position information from the sensor.

Control system 301 is powered by an AC power supply (not shown). The AC power supply, which may provide relatively low AC voltage (e.g. 24V AC), is connected across power supply terminals 300 and 302. Preferably, although not necessarily, the power supply has a frequency of 50 or 60 Hz. The power supply may have a different frequency. AC input terminal 300 is connected to a system ground 304 which is also AC common and which is also connected to ground terminal 406 of representative scroll sign module 401.

Control system 301 also comprises an array of n drive switches. Each drive switch corresponds to a particular scroll sign module. In general, n may be any positive integer number. For example, in a sign containing 4 banks, with each bank having 4 individual scroll sign modules, n=16. The array of n drive switches is schematically depicted in FIG. 7 by representative drive switches 306, 308.

Drive switches 306, 308 are connected between a common input terminal 328 and respective output terminals 314, 316. Drive switches 306, 308 may be activated by suitable control signals on their respective control signal lines 318, 320. Drive switches 306, 308 preferably comprise bi-directional switches which may source or sink current (i.e. pass current in either direction) when activated. An example of a suitable bi-directional switch that may be used for drive switches 306, 308 is a commonly available triac (thyristor), which may have a relatively low cost and may exhibit relatively little power loss when active (i.e. passing current). The control signals on control signal lines 318, 320 originate from controller 322 which provides the drive switch control signals for representative drive switches 306, 308 (and the other drive switches) via output lines 324.

In the schematic diagram of FIG. 7, output terminal 314 of representative drive switch 306 is connected to representative scroll sign module 401 via drive signal terminal 410. The other drive switches in the array of n drive switches may be associated with other scroll sign modules and may be connected to their respective scroll sign modules in a similar manner to provide similar functionality as representative drive switch 306 and representative scroll sign module 401.

In the illustrated embodiment, the input lines for all n drive switches (including representative switch 306) are connected to terminal 328. Terminal 328 is connected to the output lines 330, 332 of a pair of direction control switches 334, 336. In general, direction control switches 334, 336 need not be bi-directional and may comprise any controllable switches, such as silicon controlled rectifiers (SCR's), for example. In the illustrated embodiment, direction control switches 334, 336 are shown as triac-based switches. Direction control switches 334, 336 may be activated by suitable control signals on their respective control signal lines 338, 340. Controller 322 provides the control signals for direction control switches 334, 336 on control signal lines 338, 340 via a pair of direction control outputs 342.

The input lines 344, 346 of direction control switches 334, 336 are respectively connected to diodes 348, 350. The opposing terminals of diodes 348, 350 are connected through fuse 352 to AC terminal 302. As shown in FIG. 7, diodes 348, 350 are connected with opposing polarities, such that input line 344 of switch 334 receives only positive half-wave AC signals from AC terminal 302 and input line 346 of switch 336 receives only negative half-wave AC signals from AC terminal 302.

Since representative drive switch 306 is bi-directional, it may efficiently source or sink current. When controller 322 activates drive switch 306 using a control signal 324 on control signal line 318, switch 306 provides a connection between terminal 328 and drive signal terminal 410. Controller 322 may also activate one of direction control switches 334, 336 by providing an appropriate control signal 342 on one of input lines 338, 340. If representative drive switch 306 and direction control switch 334 are simultaneously activated, then a positive half-wave AC signal is transmitted through switches 334, 306 to drive signal terminal 410. Similarly, if representative drive switch 306 and direction control switch 336 are simultaneously activated, then a negative half-wave AC signal is transmitted through switches 336, 306 to drive signal terminal 410.

Drive signal terminal 410 is connected to motor 402 through steering diode 408 and is connected to motor 404 through steering diode 412. Steering diodes 408, 412 have opposing polarities. When a positive half-wave AC signal appears at drive signal terminal 410 (i.e. direction switch 334 and drive switch 306 are both activated), then the positive half-wave AC signal is transmitted through steering diode 408 to motor 402, but is blocked from motor 404 by steering diode 412, which is reverse biased. The positive half-wave AC signal drives motor 402 and causes scrolling of tape 18 (FIGS. 1 and 2) in a particular direction. For example, in these conditions, tape 18 may wind onto roll 14 and may unwind from roll 16. Conversely, when a negative half-wave AC signal appears at drive signal terminal 410 (i.e. direction switch 336 and drive switch 306 are both activated), then the negative half-wave AC signal is transmitted through steering diode 412 to motor 404, but is blocked from motor 402 by steering diode 408, which is reverse biased. The negative half-wave AC signal drives motor 404 and causes scrolling of tape 18 (FIGS. 1 and 2) in an opposite direction. For example, in these conditions, tape 18 may wind onto roll 16 and may unwind from roll 14.

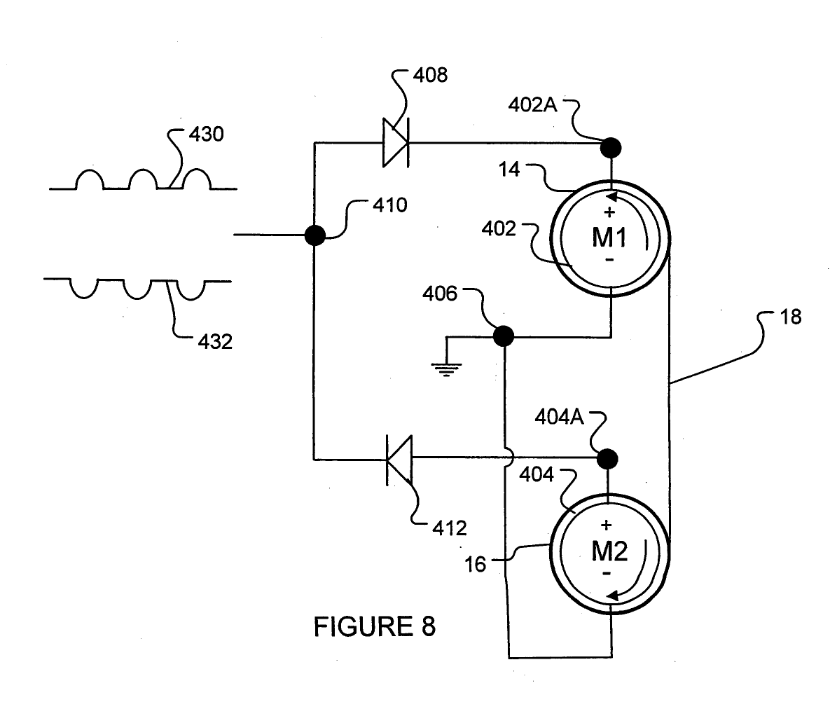

FIG. 8 is a schematic depiction of how the FIG. 7 control system operates the dual motor scroll sign module of FIGS. 1 and 2 using positive half-wave AC signals 430 and negative half-wave AC signals 432. FIG. 8 is also useful to describe the advantages of providing a scroll sign module with two motors 402, 404 to effect the movement of tape 18 between corresponding rolls 14, 18 and to maintain tension on tape 18 when it is moving (i.e. to compensate for the different effective diameters of rolls 14, 16) and when it is stopped (i.e. to provide good display characteristics). When a positive half-wave AC signal 430 appears at drive signal terminal 410, it is transmitted through steering diode 408 to terminal 402A of motor 402. Because of the polarity of motor 402, positive half-wave AC signal 430 causes motor 402 to rotate counterclockwise, winding tape 18 onto upper roll 14 and unwinding tape from lower roll 16.

Motors 402, 404 are preferably 12 or 24 volt DC motors. Although the positive half-wave signal applied to motor terminal 402A is a periodic pseudo-AC signal, the integral inductance of a typical DC motor is sufficient to effect at least some degree of current/magnetic flux integration. By proper choice of motor rating versus peak current and peak voltage, it is possible to provide a smoothly turning motor for a range of drive signal frequencies. Preferably, the drive signal frequency is approximately 50 or 60 Hz. The drive signal frequency may be different.

When tape 18 is unwound from lower roll 16, it causes motor 404 to rotate in the counterclockwise direction, generating a back EMF which (because of the polarity of motor 404) appears as a positive voltage at terminal 404A. This positive voltage causes current to flow through steering diode 412 to drive signal terminal 410 and then through steering diode 408 to assist the positive drive signal at terminal 402A of motor 402. This assisted drive signal for motor 402 may reduce the power required from positive half-wave AC signal 430 to scroll tape 18 from roll 16 onto roll 14 or may allow tape 18 to scroll more quickly from roll 16 onto roll 14. Furthermore, work is required to rotate motor 404 in the counterclockwise direction and to generate the corresponding back EMF. This work creates a desirable tension on tape 18 which helps to compensate for the different effective diameters of rolls 14, 16 and to improve the visibility of indicia located on tape 18.

When a negative half-wave AC signal 432 appears at drive signal terminal 410, it is transmitted through steering diode 412 to terminal 404A of motor 404. Because of the polarity of motor 404, negative half-wave AC signal 432 causes motor 404 to rotate clockwise, winding tape 18 onto lower roll 16 and unwinding tape 18 from upper roll 14. Unwinding tape 18 from upper roll 14 causes motor 402 to rotate in the clockwise direction, generating a back EMF which (because of the polarity of motor 402) appears as a negative voltage at terminal 402A. This negative voltage causes current to flow through steering diodes 408, 412, thereby assisting the drive signal at terminal 404A of motor 404. This assisted drive signal for motor 404 may reduce the power required from negative half-wave AC drive signal 432 to scroll tape 18 from roll 14 to roll 16 or may allow tape 18 to scroll more quickly from roll 14 to roll 16. Furthermore, work is required to rotate motor 402 in the clockwise direction and to generate the corresponding back EMF. This work creates a desirable tension on tape 18 which helps to compensate for the different effective diameters of rolls 14, 16 and to improve the visibility of indicia located on tape 18.

Referring back to FIG. 7, controller 322 may independently control any one of the n scroll sign modules within a particular scroll sign by activating one of direction control switches 334, 336 and a corresponding one of the n drive switches. Additionally or alternatively, controller 322 may control a plurality of the n scroll sign modules that are moving in the same direction by simultaneously activating one of direction control switches 334, 336 and a corresponding plurality of the n drive switches. With the FIG. 7 embodiment, a pair of direction control switches 334, 336 can control the direction for all n scroll sign modules. This configuration saves cost. Those skilled in the art will appreciate that an independent pair of control switches (and corresponding diodes) may be provided for each scroll sign module to allow for simultaneous independent control of a plurality of scroll sign modules in either direction.

Control system 301 requires relatively few wiring interconnections between control system 301 and its associated scroll sign modules. For example, as shown in FIG. 7, wiring harness 403, which connects control system 301 to representative scroll sign module 401, has only 5 connectors. Furthermore, by using inexpensive, bi-directional triac switches, control system 301 is more efficient and less costly than prior art control systems which incorporate large numbers of H-bridges and/or half-bridges. Further advantages of control system 301 include reduced conduction losses and power dissipation, as well as significantly increased reliability. These advantages arise because control system 301 avoids cross-commutation or conduction overlap between the switches/devices responsible for motor polarity changes/reversal.

Control system 301 also comprises a DC power supply circuit 354 which provides DC power to controller 322. DC power supply circuit 354 comprises diode 356 and filter/storage capacitor 358. One terminal of capacitor 358 is connected to diode 356 via line 360 and the other terminal is connected to system ground. Together, diode 356 and capacitor 358 provide a half-wave rectified and smoothed DC potential to the input terminal 364 of DC supply 354. The regulated output of DC supply 354 at terminal 366 is referred to as “Vcc”. Vcc is provided to controller 322 via a connection (not shown) and is provided to other components within control system 301 and scroll sign module 401, such as at terminals 368, 420 where Vcc is supplied as a power signal to sensor 414. Vcc is also provided in a similar manner to the sensors associated with the other scroll sign modules.

As discussed above, sensor 414 of scroll sign module 401 may be an optoelectronic sensor. Each scroll sign module may comprise a sensor which functions in a manner similar to sensor 414. A positive DC voltage Vcc (also referred to as “S+”) is continually supplied to power signal terminal 420 of sensor 414 via terminal 368 of control system 301.

Sensor 414 is activated via sensor activation terminal 428. The activation of sensor 414 in representative scroll sign module 401 is controlled by controller 322 and a representative sensor select driver 370 from among an array of n sensor select drivers. In the FIG. 7 embodiment, there are n sensor select drivers, each corresponding to a particular sensor within a particular scroll sign module. Although n may generally be any positive integer number, FIG. 7 only depicts a pair of representative sensor select drivers 370, 372. In the illustrated embodiment, sensor select drivers 370, 372 comprise transistors connected in an open collector configuration. The control signal inputs of representative sensor select drivers 370, 372 are provided by controller 322 on control signal input lines 374, 376 respectively. The outputs of representative sensor select drivers 370, 372 lead respectively to terminals 378, 380.

In the schematic illustration of FIG. 7, output terminal 378 of representative sensor select driver 370 is connected to sensor activation terminal 428 of sensor 414 in the representative scroll sign module 401. The output of each sensor select driver from among the array of n sensor select drivers is similarly connected to a corresponding sensor within a corresponding scroll sign module to provide similar functionality as representative sensor select driver 370.

Controller 322 may activate representative sensor select driver 370 by providing a suitable control signal on control signal line 374. When controller 322 activates sensor select driver 370 in this manner, sensor select output terminal 378 and sensor activation terminal 428 are pulled to system ground. The response of open collector circuit 416 depends on the presence or absence of a light signal on open collector circuit 416. As discussed above, sensor 414 is an optoelectronic sensor that reacts to the presence or absence of light which in turn is caused by the presence or absence optical markings on tape 18 (FIGS. 1 and 2). Such optical markings may comprise coded bars which alternatively absorb, transmit or reflect light, for example.

In one particular embodiment, open collector circuit 416 is active when the optical markings on tape 18 transmit light. If open collector circuit 416 is activated (e.g. by the transmission of light through the markings on tape 18) and sensor activation terminal 428 is activated (i.e. grounded), then sensor signal terminal 424 is shunted to ground. When sensor signal terminal 424 is shunted to ground, current conducts from S+ (Vcc) terminal 368 to sensor signal terminal 424 through resistor 386 and optional blocking diode 485. The current flow through resistor 386 creates a low voltage signal (Ssig) at terminal 384. Conversely, if open collector circuit 416 is inactive (e.g. by non-transmission of light through the markings on tape 18) or if sensor activation terminal 428 is not activated (i.e. not grounded), then sensor signal terminal 424 will be at a floating potential. When sensor signal terminal 424 is at a floating potential, there is no current flow through resistor 386 and, consequently, Ssig terminal 384 remains high at S+ (Vcc).

Controller 322 may ascertain the logic level status of the Ssig signal at terminal 384. Ssig terminal 384 is normally held at a high logic level by pull-up resistor 386. Consequently, a high logic level is present at Ssig terminal 384 when: (i) sensor 414 is not activated by sensor select driver 370 (i.e. sensor activation terminal 428 is not grounded); or (ii) when sensor 414 is selected, but the coded markings on the associated tape 18 act to prevent open collector circuit 416 from conducting (e.g. by transmitting, absorbing or reflecting light). A low logic level is present at Ssig terminal 384 when both: (i) sensor 414 is activated by sensor select driver 370; and (ii) the coded markings on tape 18 allow open collector circuit 416 to conduct.

Controller 322 decodes the changes in the logic levels of Ssig terminal 384 and, based on these changes in logic levels, controller 322 may determine the direction of travel of tape 18 and the position of tape 18 relative to a desired position. Controller 322 also uses the changes in the logic levels at Ssig terminal 384 to control the movement of tape 18 to precisely position tape 18 to display desired display indicia 50 (FIGS. 1 and 2).

When tape 18 is scrolled in either direction, controller 322 causes tape 18 to come to a stop at a desired location, such that a particular desired indicia can be displayed. A particular embodiment of this process is explained with reference to representative scroll sign module 410 depicted in FIGS. 7 and 8. When tape 18 is to be moved to a new location, controller 322 initially applies a constant drive signal in a particular direction as discussed above (i.e. by activating drive switch 306 and one of direction control switches 334, 336). When controller 322 determines (from sensor 414) that tape 18 has reached the desired location, controller 322 may cause tape 18 to stop scrolling by turning off drive switch 306. Even though controller 322 causes tape 18 to stop scrolling, tape 18 may overshoot of the desired location by a small amount due to momentum of rolls 14, 16, switching delays or other factors. Controller 322 then enters a final approach mode. In alternative embodiments, tape 18 need not reach the desired location before controller 322 enters the final approach mode. For example, controller 322 may determine (from sensor 414) that tape 18 has reached a vicinity of its desired location and then immediately enter its final approach mode.

In its final approach mode, controller 322 activates drive switch 306 while causing direction control switches 334, 336 to switch at a relatively high frequency, but with a switching cycle that tends to cause tape 18 to scroll towards the desired location. For example, if motor 402 was the one initially being driven (though drive switch 306 and direction control switch 334), then tape 18 may have overshot the desired location by scrolling too far onto roll 14 (FIG. 8). In such a case, controller 322 may cause direction control switches 334, 336 to switch at a relatively high frequency, but with a switching cycle wherein, for each switching period, direction control switch 336 is active for a greater percentage of time than direction control switch 334. This switching cycle of direction control switches 334, 336 will cause tape 18 to scroll slowly back onto roll 16 (i.e. back toward the desired location), while simultaneously maintaining tension on tape 18 to compensate for the different effective diameters of rolls 14, 16 and to improve the visibility of indicia located on tape 18. Control of direction control switches 334, 336 in this manner may be accomplished by pulse width modulation, for example. The switching frequency of direction control switches 334, 336 during the final approach mode may be on the order of 10-10,000 times the driving frequency of the drive signal at node 302.

During its final approach mode, controller 322 may control the relative active time of each direction control switch 334, 336 during each switching period based on the position of tape 18 relative to its desired location. Such control may be overdamped, damped or underdamped. When the final approach mode is executed in an overdamped control scenario, controller 322 will cause tape 18 to scroll slowly and directly to its desired location without any further overshoot. However, in other control scenarios, controller 322 may select the relative active time of each direction control switch 334, 336 during each switching period based on a number of control criteria, such as final position accuracy, time required to reach the desired position, acceptable degree of overshoot and the like. The relatively rapid switching of direction control switches 334, 336 during the final approach mode maintains tension on tape 18 to compensate for the different effective diameters of rolls 14, 16 and to improve the visibility of indicia located on tape 18.

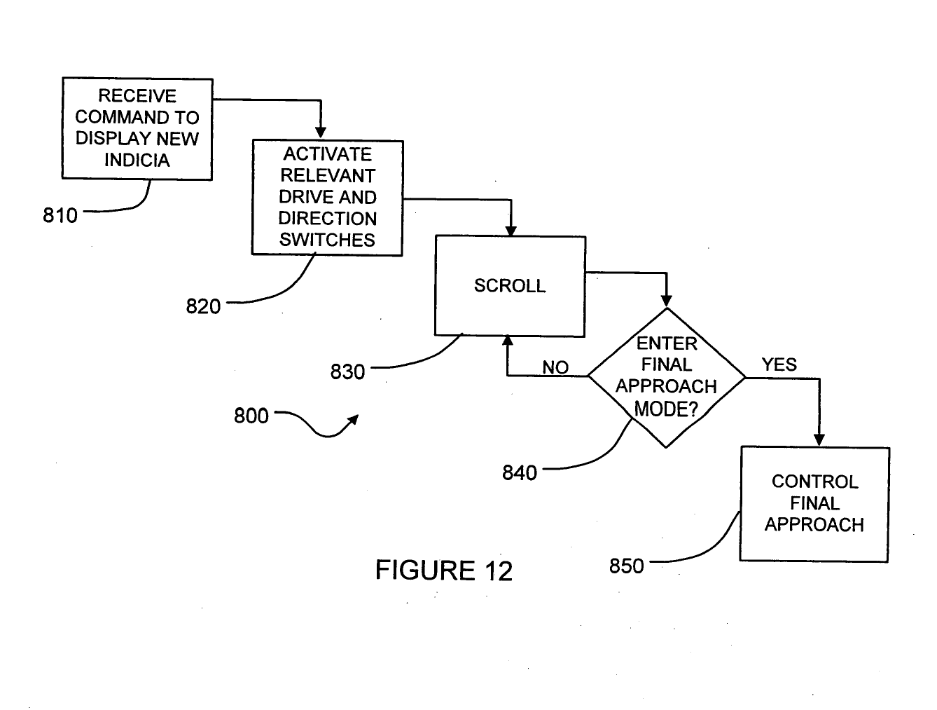

FIG. 12 is a schematic flow chart of a method 800 for operating the FIG. 1 dual motor scroll sign module using the FIG. 7 control system according to a particular embodiment of the invention. For the purpose of explanation, it is assumed that method 800 relates to representative scroll sign module 401. Method 800 commences in block 810, where controller 322 receives a command indicating that a new indicia should be displayed on module 401. In block 820, controller 322 activates drive switch 306 (i.e. the drive switch corresponding to module 410) and one of direction control switches 334, 336. Tape 18 then scrolls in one direction between rolls 14, 16 as discussed above (block 830).

When scrolling in block 830, a drive signal is imparted on a first one of motors 402, 404, thereby driving its corresponding roll and scrolling tape 18 in a particular direction. Scrolling tape 18 in the particular direction rotates the second one of motors 402, 404 in the particular direction to develop a back EMF in the second one of motors 402, 404 and to provide a desirable tension on tape 18. As discussed above, the back EMF developed in the second one of motors 402, 404 preferably assists the first one of motors 402, 404 to scroll tape 18 in the particular direction.

In block 840, controller 322 (together with sensor 414) query whether to enter final approach mode. Such a query may involve a question as to whether tape 18 has reached its desired location or whether tape 18 has reached a vicinity of its desired location. If controller 322 decides not to enter its final approach mode, then method 800 returns to block 830 and tape 18 continues scrolling. If, on the other hand, controller 322 decides to enter its final approach mode, then method 800 proceeds to block 850.

As discussed above, in the final approach mode of block 850, controller 322 switches direction control switches 334, 336 at a relatively high frequency (as compared to the signal at terminal 302), but controls the relative active time of each direction control switch 334, 336 during each switching period. In this manner, tension is maintained on tape 18 as it closes in on its new desired location.

As shown in FIG. 7, control system 301 also comprises a radio frequency transceiver 388, with its associated antenna 390. Transceiver 388 is operationally connected to controller 322 to receive queries and commands from a remotely located operator interface console (not shown) and to thereby provide a wireless interface link to controller 322. This wireless interface link allows for the remotely located operator to ascertain certain information known to controller 322. Such information may include, for example, the current display on the scroll sign system, error messages, and other diagnostic-related information. The wireless interface link may also allow a user to modify the current display on the scroll sign system. Wireless' communications devices are well known to those skilled in the art.

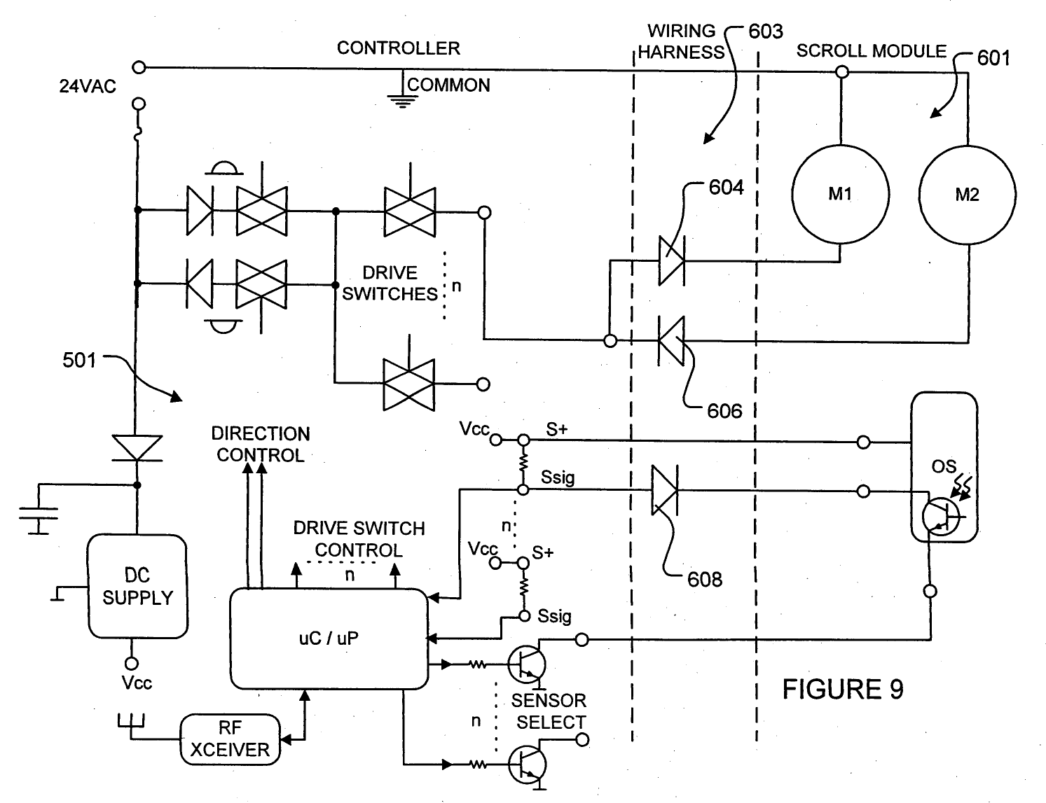

FIG. 9 depicts a partially schematic block diagram of a scroll sign module control system 501 and a scroll sign module 601 according to an alternative embodiment of the invention. Control system 501 and scroll sign module 601 of FIG. 9 are similar in many respects to control system 301 and scroll sign module 401 of FIG. 7. A principal difference with control system 501 and scroll sign module 601 of FIG. 9 is that steering diodes 604, 606 and sensor diode 608 are located in the wiring harness 603 between control system 501 and scroll sign module 601, rather than inside of the individual scroll sign modules. Diodes 604, 606, 608 may be located in breakout box 228 (FIG. 5).

In the FIG. 9 configuration, wiring harness 603 connecting control system 501 to representative scroll sign module 601 comprises 6 wires, which represents one additional wire when compared to wiring harness 403 (FIG. 7). However, the FIG. 9 configuration provides the advantage that diodes 604, 606, 608 need not be replaced if there is a malfunction in one of the scroll sign modules connected to control system 501. Those skilled in the art will appreciate that diodes 604, 606, 608 are solid state devices which are much less susceptible to failure than the mechanical and electro-mechanical components contained in the scroll sign modules.

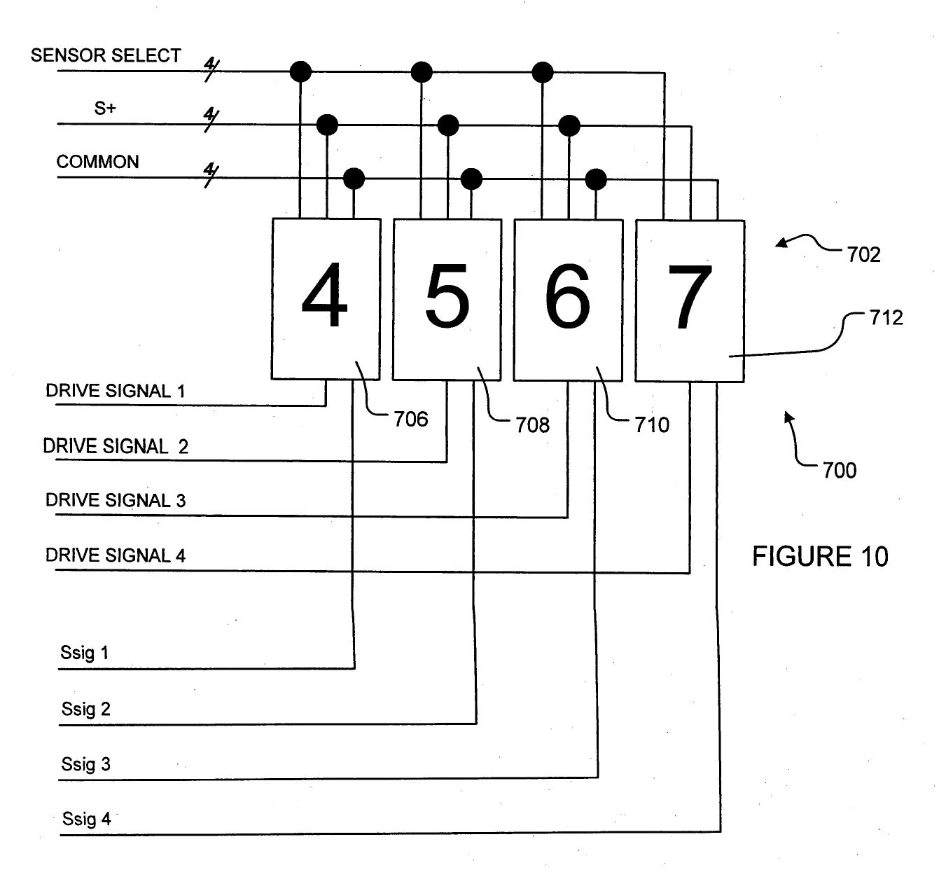

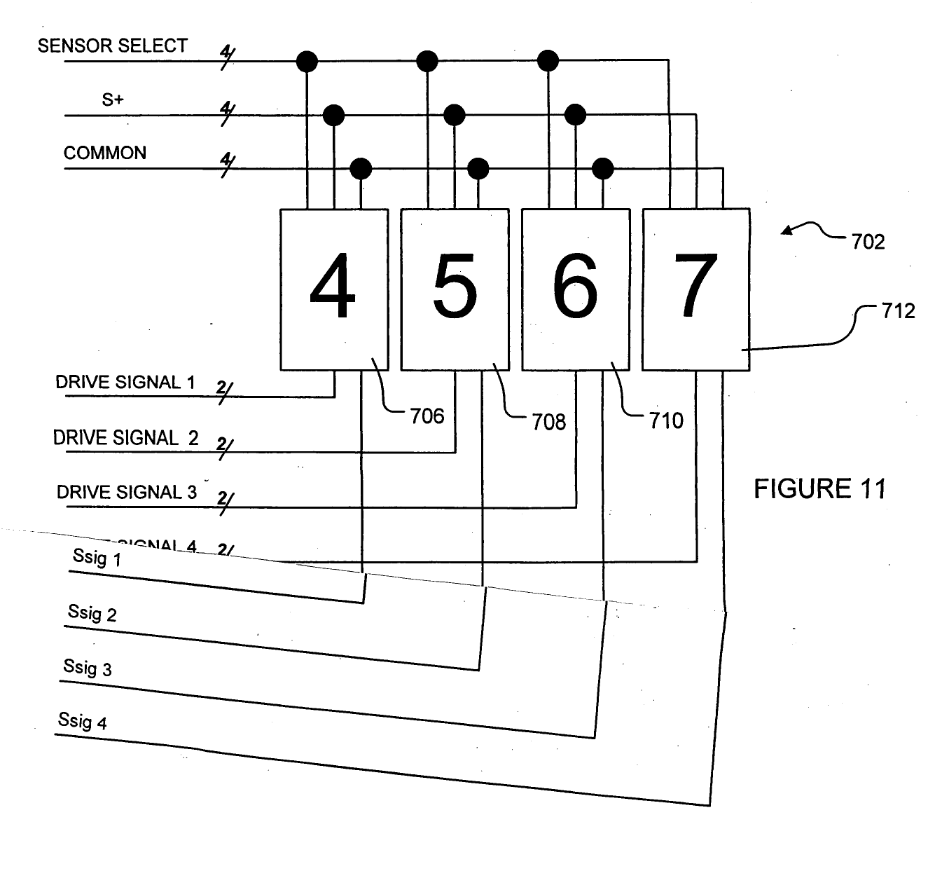

FIGS. 10 and 11 schematically illustrate the differences between the wiring interconnections of control system 301 and control system 501 and the scroll sign modules to which they are connected.

FIG. 10 is a schematic diagram of the wiring interconnections required between FIG. 7 control system 301 (not shown in FIG. 10) and a single bank 702 of four scroll sign modules 706, 708, 710, 712. The wiring harness (not shown in FIG. 10) associated with each scroll sign module 706, 708, 710, 712 provides 5 connections, which include: the common ground wire (connecting terminals 300 and 406 of FIG. 7); the sensor select wire (connecting terminals 378 and 428 of FIG. 7); the S+ wire at Vcc (connecting terminals 368 and 420 of FIG. 7); the Ssig wire (connecting terminals 384 and 487 of FIG. 7); and the drive signal wire (connecting terminals 310 and 314 of FIG. 7).

FIG. 11 is a schematic diagram of the wiring interconnections required between FIG. 9 control system 501 (not shown in FIG. 10) and a single bank 702 of four scroll sign modules 706, 708, 710, 712. The wiring of FIG. 11 differs from that of FIG. 10 because control system 501 requires that the wiring harness associated with each scroll sign module 706, 708, 710, 712 (not shown in FIG. 10) provide 6 connections, which include all of the wires described above for the FIG. 10 embodiment plus one additional drive signal wire.

As will be apparent to those skilled in the art in the light of the foregoing disclosure, many alterations and modifications are possible in the practice of this invention without departing from the spirit or scope thereof. For example:
Controller 322 of control system 301 (FIG. 7) and the controller depicted in control system 501 (FIG. 9) may comprise one or more programmable processor(s) which may include, without limitation, embedded microprocessors, dedicated computers, groups of data processors, programmable logic arrays or the like. Some functions of these controllers may be implemented in software, while others may be implemented with specific hardware devices. The operation of these controllers may be governed by appropriate firmware/code residing and executing therein, as is well known in the art.
The functionality of sensor select drivers 370, 372 of control system 301 (FIG. 7) and the sensor select drivers depicted in control system 501 (FIG. 9) may be accomplished by a wide variety of circuit elements other than the bipolar transistors shown in the illustrated embodiment. The invention should be understood to include such alternative designs.
In the schematic illustrated of FIG. 7, only two representative Ssig terminals 384, 385 are depicted. Those skilled in the art will appreciate, however, that control system 301 comprises n Ssig terminals, one of which corresponds to each scroll sign module. In alternative embodiments, a smaller number of Ssig terminals are shared between a plurality of scroll sign modules. For example, all of the scroll sign modules in a particular bank may share the same Ssig terminal by having the sensor output terminals of their respective sensors connected to the same Ssig terminal. Controller 322 may then use the sensor select drivers and sensor activation terminals associated with each scroll sign module to select one scroll sign module from within the bank (and its corresponding sensor) to be detected on the Ssig terminal. Controller 322 avoids having multiple conflicting signals on the Ssig terminal by only activating one sensor select driver at a particular time. Those skilled in the art will appreciate that there is a tradeoff between the versatility and speed associated with having one Ssig terminal for each scroll sign module and the cost savings associated with having fewer Ssig terminals. In some circumstances, the number of Ssig terminals may be limited by the number of available I/O pins on controller 322.
Sensors 12, 414 (FIGS. 1 and 6) are described as being optoelectronic sensors. In alternative embodiments, these sensors could be other types of position sensors, such as acoustic, magnetic, electromagnetic or physical sensors. Such other types of sensors may detect other types of markings on tape 18. For example, such markings may be magnetic, physical or other types of detectable markings.
In the embodiments of FIGS. 7 and 9, both of the motors in a scroll sign module are connected through opposing polarity diodes to a common drive terminal. This is not necessary. In an alternative embodiment, it is possible to have separate drive terminals for each motor in a particular scroll sign module. In such an embodiment, as resistor and a suitably connected diode could be connected across the motor terminals, so as to permit a signal on the corresponding drive terminal to drive the motor and to dissipate back EMF when the motor is rotated by tape 18. Each motor drive terminal could be powered by a half wave rectified signal or each motor drive terminal could be powered by a full wave signal and connected to the motor by a diode having a suitable polarity.

What is claimed is:

1. A scroll sign module comprising:
first and second rolls having first and second laterally extending, substantially parallel roll axes, each of the first and second rolls having a corresponding outer surface and defining a corresponding cavity;
a tape bearing visual indicia, the tape entrained over the outer surfaces of the first and second rolls; and
first and second motors, at least a portion of the first motor located in the cavity of the first roll and at least a portion of the second motor located in the cavity of the second roll;
wherein the first and second motors are respectively coupled to rotate the first and second rolls about their roll axes.

2. A scroll sign module according to claim 1 wherein the tape comprises a first tape portion entrained over at least a part of the outer surface of the first roll, a second tape portion entrained over at least a part of the outer surface of the second roll and an intermediate tape portion that extends between the first and second rolls.

3. A scroll sign module according to claim 2 wherein the first motor is coupled to scroll the tape in a first direction and to thereby increase a size of the first tape portion relative to that of the second tape portion and wherein the second motor is coupled to scroll the tape in a second direction and to thereby increase a size of the second tape portion relative to that of the first tape portion.

4. A scroll sign module according to claim 3 wherein the first motor is connected such that scrolling the tape in the second direction creates a first back EMF in the first motor, the first back EMF assisting the second motor to scroll the tape in the second direction and wherein the second motor is electronically connected such that scrolling the tape in the first direction creates a second back EMF in the second motor, the second back EMF assisting the first motor to scroll the tape in the first direction.

5. A scroll sign module according to claim 4 wherein corresponding terminals of the first and second motors are connected through first and second opposing polarity diodes to a common drive signal terminal.
